(19) United States
(12) Patent Application Publication
(10) Pub. No.: US 2004/0024082 A1
(43) Pub. Date: Feb. 5, 2004

(54) Method for using antimicrobial polymers for the protection of building and monuments

(76) Inventors: Peter Ottersbach, Windeck (DE); Beate Kossmann, Hagen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/450,040

(22) PCT Filed: Nov. 13, 2001
(86) PCT No.: PCT/EP01/13093

(30) Foreign Application Priority Data
Dec. 13, 2000 (DE) 100 62 201.1

(51) Int. Cl. C08K 3/00

(52) U.S. Cl. 523/122

(57) ABSTRACT

The invention relates to a process for using antimicrobial polymers in the protection of buildings or of monuments, by impregnating surfaces with an antimicrobial polymer.

The invention relates to a process for using antimicrobial polymers in the protection of buildings or of monuments.

As a consequence of the development of civilization, the millennia have progressively generated valuable cultural monuments, and recently to an increasing extent industrial monuments. An ever greater problem in this connection is the prevention of disintegration of these monuments, specifically in the light of rising levels of air pollution. This results in chemical attack on the surfaces of the monuments, and this makes it easier for microbes to decompose these surfaces. This form of decomposition is also termed biocorrosion. Molds, such as Aspergillus niger, play a significant part in this process. They penetrate the pores of the materials, be they concrete, sandstone, wood or even glass, and their metabolism causes insidious disintegration of the surfaces affected. In Germany alone about 30 billion euros are expended annually on the preservation of monuments.

In addition, there is naturally also a desire for prophylactic protection for new buildings, so that the problems described are completely avoided.

In principle, there have hitherto been two approaches to countering this problem. Firstly, a protective layer made from hydrophobic coatings is applied to the restored areas in order to keep water and microbes away from the surface. However, the success of this approach is only short-term, since the microbes find ways of adhering even to hydrophobic surfaces. The result is damage to the coatings, allowing microbial attack through the protective layer and finally resulting in partial breakaway of the areas affected.

The second approach consists in large-scale use of low-molecular-weight biocides which are applied, mostly as an additive in surface coatings, to the surfaces to be protected. Since in such cases even one single downpour often washes more than half of the active substances away, this type of surface protection is generally employed only for interior surfaces, such as those of frescos, sculptures, or paintings. Another grave disadvantage of this method is the toxicity of the biocides, the result being that restorers can only apply each of these biocide systems for a short period while using respiratory and skin protection.

European patent application 0 862 858 discloses that copolymers of tert-butylaminoethyl methacrylate, which is a methacrylate with a secondary amino function, inherently have microbicidal properties. The antimicrobial action of these polymeric systems is closely associated with their three-dimensional structure, conformation, and available surface area. They are suitable especially in application sectors where long-lasting surface-active protection from microbial attack is important.

A continuing problem currently is the weathering resistance and light stability of these antimicrobial systems in long-term use.

It is an object of the present invention, therefore, to provide a process for the biocorrosion-protection of buildings, monuments or items of cultural heritage made from stone, minerals, concrete, wood, glass, clay or ceramics.

Surprisingly, it has been found that this object can be achieved in a way which is ideal in terms of cost-effectiveness and the environment, by using antimicrobial polymers.

The present invention therefore provides a process for the surface-impregnation of construction materials to counter microbial infestation, where a solution of an antimicrobial polymer is applied to the surfaces.

For the purposes of the present invention, construction materials are any of the materials usually used in housing construction, e.g. natural or artificial stone, minerals, concrete, wood, gypsum, glass, clay, cement, mortar, or ceramics.

The process of the invention is used in particular for preserving buildings which are old or subject to severe environmental exposure, for example bridges, dams, river-bank or shoreline reinforcements, quays, hangars, castles, chateaux and palaces, churches, power plant chimneys, etc.

In the process of the invention, the antimicrobial polymer may be dissolved in an organic solvent or dispersed in an aqueous solvent, and introduced into a surface, which may be porous, of the material to be treated. This may be done by painting or spraying, for example, or inserting the substrate into an appropriate solution, i.e. saturating the substrate, if necessary at an elevated pressure, so that the result is a surface impregnated with antimicrobial polymer. The antimicrobial polymer here is located in the pores of the substrate, enabling efficient defense, not only spatial but also chemical, against any potential microbial attack. Since the antimicrobial property is inherent to the polymer there can in principle be no leaching of the active species. In addition, antimicrobial polymers generally bear hydrophilic groups which lead to swelling of the polymer in contact with water. In the presence of moisture, therefore, which is required for microbial attack, the polymer swells in the pores of the substrate, finally leading to complete sealing of these pores. Since the polymeric structure of the antimicrobial polymers makes them markedly less toxic than low-molecular-weight biocides, the use of the substances for impregnation of materials need not involve any environmental or toxicological hazard.

In order to eliminate any disadvantages in principle of the antimicrobial polymers, e.g. any insufficiency of light resistance or of weathering resistance, the process may be combined with the employment of an additional protective coating whose task is purely to maintain the types of resistance described and, where appropriate, to contribute other desired mechanical or visual properties. In this embodiment of the invention, the surface-impregnation is followed by another surface treatment for sealing. This type of two-layer protection can be assumed to give a high degree of protection to the material, since even if there is damage to the first protective layer a microbial attack on the substrate is effectively suppressed by the antimicrobial polymer present in the pores.

The further protective layer applied by the sealing process preferably comprises no monomers, but instead comprises for example polymethyl methacrylate as UV protection.

The surfaces treated in this way exhibit an antimicrobial action which is lasting and capable of resisting environmental effects and physical stresses. These coatings comprise no low-molecular-weight biocides.

Migration of environmentally problematic substances is therefore effectively eliminated over the entire period of their use.

For preparing the microbial polymers it is preferable to use nitrogen- and phosphorus-functionalized monomers.

Particularly preferred monomers are 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-(3-dimethylaminopropyl)acrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyidimethylammonium bromide, 2-methacryloyloxyethyl-4-benzoyldimethylammonium bromide allyltriphenylphosphonium bromide, allyltriphenylphosphonium chloride, 2-acrylamido-2-methyl-1-propanesulfonic acid, 2-diethylaminoethyl vinyl ether, and 3-aminopropyl vinyl ether.

Use of the Modified Polymer Substrates

The present invention also provides the use of the antimicrobial surfaces of the invention in the protection of buildings or of monuments. Surfaces of this type are preferably based on construction materials, e.g. concrete, cement, mortar, natural stone, artificial stone, minerals, clays, wood, glass, or ceramics, whose surfaces have been impregnated with the polymers of the invention.

The examples below are given for further description of the present invention and give further illustration of the invention but are not intended to restrict its scope as laid out in the claims.

### EXAMPLE 1

50 ml of dimethylaminopropylmethacrylamide (Aldrich) and 250 ml of ethanol form an initial charge in a three-necked flask and are heated to 65° C. under a stream of argon. 0.6 g of azobisisobutyronitrile dissolved in 20 ml of ethyl methyl ketone is then slowly added dropwise, with stirring. The mixture is heated to 70° C. and stirred for 72 hours at this temperature. Once this period has expired, the reaction mixture is stirred into 1.5 l of demineralized water, whereupon the polymeric product precipitates. Once the product has been filtered off, the filter residue is washed with 100 ml of a mixture made from ethanol/demineralized water in a ratio of 1:1, in order to remove any residual monomers still present. The product is then dried in vacuo for 24 hours at 50° C. 2 g of the product are dissolved in 10 g of ethanol and applied to a piece of sandstone of dimensions 3×3 cm and 0.5 cm thickness, using a 100 micrometer doctor. The stone is then dried at 50° C. for 24 hours.

### EXAMPLE 1a

The stone from example 1 is placed, with its coated side upward, on the base of a glass beaker which contains 20 ml of a test microbial suspension of Staphylococcus aureus, and is shaken. After a contact time of 4 hours, 1 ml of the test microbial suspension is removed and the number of microbes in the test mixture is determined. After expiry of this period, no remaining Staphylococcus aureus microbes are detectable.

### EXAMPLE 1b

The stone from example 1 is placed, with its coated side upward, on the base of a glass beaker which contains 20 ml of a test microbial suspension of Pseudomonas aeruginosa, and is shaken. After a contact time of 4 hours, 1 ml of the test microbial suspension is removed and the number of microbes in the test mixture is determined. After expiry of this period, the number of microbes has fallen from 10⁷ to 10² microbes per ml.

### EXAMPLE 1c

In each case, an impregnated piece of stone from example 1 is inoculated with, respectively, Chlorella sp., Trentepohlia sp., Gloeocapsa sp., Calothrix sp., and Aspergillus niger. These specimens are then placed in an incubator for 3 weeks. No growth is observed on any of the impregnated pieces of stone, unlike on concurrent control samples.

### EXAMPLE 2

50 ml of tert-butylaminoethyl methacrylate (Aldrich) and 250 ml of ethanol form an initial charge in a three-necked flask and are heated to 65° C. under a stream of argon. 0.6 g of azobisisobutyronitrile dissolved in 20 ml of ethyl methyl ketone is then slowly added dropwise, with stirring. The mixture is heated to 70° C. and stirred for 72 hours at this temperature. Once this period has expired, the reaction mixture is stirred into 1.5 l of demineralized water, whereupon the polymeric product precipitates. Once the product has been filtered off, the filter residue is washed with 100 ml of a mixture made from ethanol/demineralized water in a ratio of 1:1, in order to remove any residual monomers still present. The product is then dried in vacuo for 24 hours at 50° C. 2 g of the product are dissolved in 10 g of ethanol and applied to a piece of sandstone of dimensions 3×3 cm and 0.5 cm thickness, using a 100 micrometer doctor. The stone is then dried at 50° C. for 24 hours.

### EXAMPLE 2a

The stone from example 2 is placed, with its coated side upward, on the base of a glass beaker which contains 20 ml of a test microbial suspension of Staphylococcus aureus, and is shaken. After a contact time of 4 hours, 1 ml of the test microbial suspension is removed and the number of microbes in the test mixture is determined. After expiry of this period, no remaining Staphylococcus aureus microbes are detectable.

### EXAMPLE 2b

The stone from example 2 is placed, with its coated side upward, on the base of a glass beaker which contains 20 ml of a test microbial suspension of Pseudomonas aeruginosa, and is shaken. After a contact time of 4 hours, 1 ml of the test microbial suspension is removed and the number of microbes in the test mixture is determined. After expiry of this period, the number of microbes has fallen from 10⁷ to 10² microbes per ml.

### EXAMPLE 2c

In each case, an impregnated piece of stone from example 2 is inoculated with, respectively, Chlorella sp., Trentepohlia sp., Gloeocapsa sp., Calothrix sp., and Aspergillus niger. These specimens are then placed in an incubator for 3 weeks. No growth is observed on any of the impregnated pieces of stone, unlike on concurrent control samples.

### EXAMPLE 3

50 ml of tert-butylaminoethyl methacrylate (Aldrich) and 250 ml of ethanol form an initial charge in a three-necked flask and are heated to 65° C. under a stream of argon. 0.6 g of azobisisobutyronitrile dissolved in 20 ml of ethyl methyl ketone is then slowly added dropwise, with stirring. The mixture is heated to 70° C. and stirred for 72 hours at this temperature. Once this period has expired, the reaction mixture is stirred into 1.5 l of demineralized water, whereupon the polymeric product precipitates. Once the product has been filtered off, the filter residue is washed with 100 ml of a mixture made from ethanol/demineralized water in a ratio of 1:1, in order to remove any residual monomers still present. The product is then dried in vacuo for 24 hours at 50° C. 0.5 g of the product is dissolved in 10 g of ethanol. A beechwood plaque of dimensions 2×3 cm and thickness 1 cm is placed into this solution for a period of 30 minutes. The wood is then dried at 50° C. for 24 hours.

### EXAMPLE 3a

The piece of wood from example 3 is held in place on the base of a glass beaker which contains 20 ml of a test microbial suspension of Staphylococcus aureus, and is shaken. After a contact time of 4 hours, 1 ml of the test microbial suspension is removed, and the number of microbes in the test mixture is determined. After expiry of this period, no remaining Staphylococcus aureus microbes are detectable.

### EXAMPLE 3b

The piece of wood from example 3 is held in place on the base of a glass beaker which contains 20 ml of a test microbial suspension of Pseudomonas aeruginosa, and is shaken. After a contact time of 4 hours, 1 ml of the test microbial suspension is removed, and the number of microbes in the test mixture is determined. After expiry of this period, no remaining Staphylococcus aureus microbes are detectable.

### EXAMPLE 3c

In each case, an impregnated piece of wood from example 3 is inoculated with, respectively, Chlorella sp., Trentepohlia sp., Gloeocapsa sp., Calothrix sp., and Aspergillus niger. These specimens are then placed in an incubator for 3 weeks. No growth is observed on any of the impregnated pieces of wood, unlike on concurrent control samples.

### EXAMPLE 4

50 ml of tert-butylaminoethyl methacrylate (Aldrich) and 250 ml of ethanol form an initial charge in a three-necked flask and are heated to 65° C. under a stream of argon. 0.6 g of azobisisobutyronitrile dissolved in 20 ml of ethyl methyl ketone is then slowly added dropwise, with stirring. The mixture is heated to 70° C. and stirred for 72 hours at this temperature. Once this period has expired, the reaction mixture is stirred into 1.5 l of demineralized water, whereupon the polymeric product precipitates. Once the product has been filtered off, the filter residue is washed with 100 ml of a mixture made from ethanol/demineralized water in a ratio of 1:1, in order to remove any residual monomers still present. The product is then dried in vacuo for 24 hours at 50° C. 2 g of the product are dissolved in 10 g of ethanol and applied to a piece of concrete of dimensions 2×3 cm and 1 cm thickness, using a 100 micrometer doctor. The piece of concrete is then dried at 50° C. for 24 hours.

### EXAMPLE 4a

The piece of concrete from example 4 is placed, with its coated side upward, on the base of a glass beaker which contains 20 ml of a test microbial suspension of Staphylococcus aureus, and is shaken. After a contact time of 4 hours, 1 ml of the test microbial suspension is removed and the number of microbes in the test mixture is determined. After expiry of this period, no remaining Staphylococcus aureus microbes are detectable.

### EXAMPLE 4b

The piece of concrete from example 4 is placed, with its coated side upward, on the base of a glass beaker which contains 20 ml of a test microbial suspension of Pseudomonas aeruginosa, and is shaken. After a contact time of 4 hours, 1 ml of the test microbial suspension is removed and the number of microbes in the test mixture is determined. After expiry of this period, the number of microbes has fallen from 10⁷ to 10² microbes per ml.

### EXAMPLE 4c

In each case, an impregnated piece of concrete from example 4 is inoculated with, respectively, Chlorella sp., Trentepohlia sp., Gloeocapsa sp., Calothrix sp., and Aspergillus niger. These specimens are then placed in an incubator for 3 weeks. No growth is observed on any of the impregnated pieces of concrete, unlike on concurrent control samples.

What is claimed is:

1. A process for the surface-impregnation of construction materials to counter microbial infestation,
which comprises
applying a solution of an antimicrobial polymer to the surfaces.

2. The process as claimed in claim 1,
wherein
the construction materials are natural or artificial stone, minerals, concrete, wood, gypsum, glass, clay, cement, mortar, or ceramics, in each case processed or unprocessed.

3. The process as claimed in claim 1 or 2,
wherein
the construction materials are painted or sprayed with or saturated by the solution of the microbicidal polymer.

4. The process as claimed in any of claims 1 to 3,
wherein
after the surface-impregnation process another surface treatment is carried out for sealing.

5. The process as claimed in claim 4,
wherein
no antimicrobial polymers are present in the sealing layer.

6. The process as claimed in any of claims 1 to 5,
wherein
the antimicrobial polymers are dissolved in an organic solvent or are dispersed in an aqueous solvent.

7. The process as claimed in any of claims 1 to 6,
wherein
the microbicidally active polymers are prepared from at least one nitrogen- or phosphorus-functionalized monomer.

8. The process as claimed in any of claims 1 to 7,
wherein
the microbicidally active polymers were prepared from at least one of the following monomers:
2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-(3-dimethylaminopropyl)acrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyidimethylammonium bromide, 2-methacryloyloxyethyl-4-benzoyldimethylammonium bromide allyltriphenylphosphonium bromide, allyltriphenylphosphonium chloride, 2-acrylamido-2-methyl-1-propanesulfonic acid, 2-diethylaminoethyl vinyl ether, and 3-aminopropyl vinyl ether.

9. The use of the impregnated construction materials in the protection of buildings or of monuments.
